(19) United States
(12) Patent Application Publication
(10) Pub. No.: US 2012/0084809 A1
(43) Pub. Date: Apr. 5, 2012

(54) SYSTEM AND METHOD ENABLING VIEWERS TO SELECT BETWEEN A PLURALITY OF SCHEDULED ADVERTISEMENTS

(76) Inventor: Jennifer Schultz, Johns Creek, GA (US)

(21) Appl. No.: 12/894,971

(22) Filed: Sep. 30, 2010

(51) Int. Cl. H04N 7/10

(52) U.S. Cl. 725/34

(57) ABSTRACT

A method and interactive advertisement selection system for enabling a television viewer to select between a plurality of advertisements scheduled for an advertising block of time. The viewer utilizes an advertisement selection mechanism such as a television remote control or other computing device to indicate the desire to skip an advertisement currently being shown. An advertisement selection server receives the skip indication, stops the current advertisement, selects a next advertisement from a list of advertisements scheduled for the advertising block, and starts the next advertisement. The server ensures selected advertisements will fit within the advertising block. Records are maintained of which advertisements were viewed in their entirety, partially viewed, or skipped.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

The present invention relates to television (TV) delivery systems. More particularly, and not by way of limitation, the present invention is directed to a system and method for enabling viewers to select between a plurality of scheduled advertisements.

Digital Video Recorders (DVRs) currently allow viewers to skip advertisements either by filtering them out, or by allowing viewers to fast forward through advertisements. Using DVR technology, viewers can record programs (content) for viewing later. When the viewer watches the content, she can fast-forward through the advertisements.

This creates a problem because most television content is supported through advertising revenue, which is proportioned based on an estimate of how many people will watch the advertisement. With fewer people watching advertisements, but still using the service, television content might become underfunded.

Advertisers are faced with a number of challenges: (1) how to get viewers to watch advertisements when DVR technology enables them not to; (2) how to measure audience numbers when DVR technology enables viewers to watch at different times; and (3) how to capitalize on monitoring viewer habits.

### BRIEF SUMMARY OF THE INVENTION

The present invention enables viewers to select between a plurality of advertisements scheduled during a particular television program. In one embodiment, the viewer is able to “surf” among the scheduled advertisements and only watch the ones that are of interest. Since advertising blocks are of fixed length, the viewer still has to view advertisements for the same amount of time, but has more choice in what advertisements are viewed.

In one embodiment, the present invention is directed to a computer-controlled method in an interactive advertisement unit for enabling a television viewer to select between a plurality of advertisements scheduled for an advertising block of time. The method includes the steps of starting to show an advertisement; monitoring by a server, a communication link to an advertisement selection mechanism controlled by the viewer; receiving by the server, an indication that the viewer activated the advertisement selection mechanism; and in response to receiving the indication, stopping the advertisement currently being shown and starting another advertisement.

In another embodiment, the present invention is directed to an interactive advertisement selection system for enabling a television viewer to select between a plurality of advertisements scheduled for an advertising block of time. The system includes a list of advertisements to be shown to the viewer during the advertising block of time; an advertisement selection mechanism controlled by the viewer; and an advertisement selection server in communication with the advertisement selection mechanism. The server includes communication means for receiving an indication that the viewer activated the advertisement selection mechanism; and means, responsive to receiving the indication, for stopping an advertisement currently being shown, selecting a next advertisement from the list of advertisements, and starting the selected next advertisement.

In another embodiment, the present invention is directed to an advertisement selection server in an interactive advertising unit for enabling a television viewer to select between a plurality of advertisements scheduled for an advertising block of time. The server includes communication means for receiving from an advertisement selection mechanism at the viewer's premises, an indication that the viewer activated the selection mechanism; and means, responsive to receiving the indication, for stopping an advertisement currently being shown and starting another advertisement.

Ad surfing benefits viewers by enabling them to easily surf over advertisements they are not interested in so they can watch more interesting advertisements. In addition, the ad surfing system is easier to use than the harder steps of pre-recording a program or pausing a program at the beginning so that advertisements can be outright skipped. Therefore, viewers are more likely to use the ad surfing system, especially when they want to watch a program immediately, and it is not pre-recorded.

Ad surfing also benefits advertisers and broadcast networks. It benefits advertisers because advertisements that are chosen by viewers are more likely to be viewed from start to finish than advertisements they do not choose. It benefits broadcast networks because when viewers are interacting with a television and choosing advertisements, they are less likely to navigate to a different channel, or leave the room for the duration of the advertisements.

### BRIEF DESCRIPTION OF THE SEVERAL VIEWS OF THE DRAWING

In the following section, the invention will be described with reference to exemplary embodiments illustrated in the figures, in which:

FIG. 1 is a simplified block diagram of an interactive advertisement selection system in an exemplary embodiment of the present invention; and

FIGS. 2A-2B are portions of a flow chart illustrating the steps of an exemplary embodiment of the method of the present invention.

### DETAILED DESCRIPTION OF THE INVENTION

The present invention provides an automated system and method for enabling a television viewer to select between a plurality of scheduled advertisements. In one embodiment, cable TV providers use modem two-way Set Top Boxes (STBs) to enable viewers to “advertisement surf” away from advertisements they are not interested in. Viewers may activate the service by clicking an “ad surf” button on their TV remote or a programmable computing device for use with two-way STBs. Activating the service may send a signal to a linear or Video On Demand (VOD) video server, changing the displayed advertisement. In one embodiment, the server steps through a series of queued advertisements each time the viewer clicks the ad surf button. The linear or VOD server knows the length of the advertising block and the length of each queued advertisement, and allows the viewer to change advertisements as much as desired within the limits established by the length of the block and the lengths of the individual advertisements. When the advertising block expires, regular television content is again displayed. The server may also record how long each advertisement is viewed and the time of day when it is viewed.

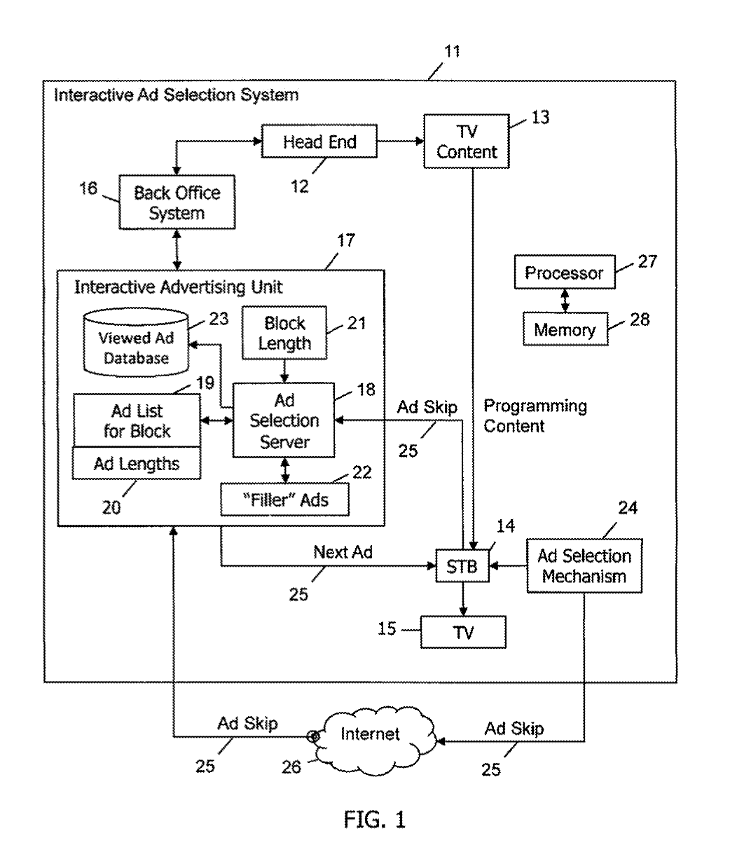

FIG. 1 is a simplified block diagram of an interactive advertisement selection system 11 in an exemplary embodiment of the present invention. The system includes a head end 12, which delivers TV content 13 to the viewer's STB 14 and TV 15. The system also includes a back office system 16 and an interactive advertising unit 17. The advertising unit includes an Ad Selection (AS) Server 18 for selecting advertisements in response to viewer input. The AS Server selects the advertisements from a list of advertisements 19 for a given advertising block. The list may include an indication of the length 20 of each advertisement, or the lengths may be input separately. The AS Server also receives as an input, the block length 21 of the given advertising block. The AS Server additionally has access to “filler” advertisements 22 for use as described below. A viewed advertisement database 23 stores information related to what advertisements the viewer chose to watch, which ones were skipped, which ones were partially viewed, and the length of time each partially-viewed advertisement was viewed.

An advertisement selection mechanism 24 (for example, the viewer's remote control device or other computing device) enables the viewer to input a command to skip the advertisement currently being shown. The STB 14 forwards the “Ad Skip” command 25 to the AS Server 18. Alternatively, when the viewer is using a computing device such as a laptop or notebook computer, or a programmable smart phone or Personal Digital Assistant (PDA), the Ad Skip command may be sent to the AS Server via the Internet 26, telephone, or other network.

A functional unit of the interactive advertisement selection system (for example the back office system 16) may provide the viewer's software remote identifier and status to the interactive advertising unit 17. If the viewer has interactive capability, the viewer may activate the advertisement selection service by clicking the “ad surf” button on the TV remote or programmable computing device 24.

In different embodiments, the interactive advertisement selection system 11 and the interactive advertising unit 17 and AS Server 18 may be controlled by one or more processors 27 such as microprocessors or other suitable processing devices executing computer program instructions stored on a memory 28.

The advertisements themselves may be stored as a separate linear or VOD set of advertisements, being preselected in a particular order for a particular time frame. For example, without viewer intervention, Advertisements-A, B, and C would play during a given advertising block. If the viewer intervenes, however, and watches only part of an advertisement or skips an advertisement entirely, then Advertisements-A, B, C, D, E, and F could potentially play (though not necessarily all the way through).

Linear TV is a television service where the viewer has to watch a scheduled TV program at the particular time the program is offered, and on the particular channel the program is presented on. Opposite of this would be incorporating the use of so-called time-shift devices such as DVRs, Video Cassette Recorders (VCRs), or VOD services. For the linear TV case, advertisements would initially be also linear (A, B, and C), but if the viewer chooses to ad surf, a linear-to-on-demand link may switch the advertisements to a VOD format, to play an existing set of advertisements in a set order, then returning to the linear broadcast. For the VOD case, all content would be VOD.

The AS Server 18 also makes adjustments when the total viewing time of selected advertisements does not perfectly fit the block length 21 of the advertising block. For example, as a viewer surfs through the advertisements, a two-minute advertising block might be filled with two thirty-second advertisements that were watched in their entirety, twenty seconds of Advertisement-A, and twenty seconds of Advertisement-B. At that point, the time remaining in the advertising block may not be able to fit an entire regular advertisement. In this case, the AS Server may insert “filler ads”, for example, still or moving frame “banner” advertisements, or specially designed mini-video-ads intended to take up the remaining time in the advertising block.

In one embodiment, any surfed advertisements that are only partially viewed during a given advertising block may be marked and shown during the next advertising block, depending on advertiser preference. This ensures that all advertisements paid for by advertisers are actually shown in their entirety. Thus, in this embodiment the viewer can postpone watching an advertisement he is less interested in, but cannot eliminate it. Over time, when using targeted advertisement techniques, advertisers may not schedule such advertisements for showing during this type of program if the advertisements are repeatedly skipped, partially viewed, or postponed.

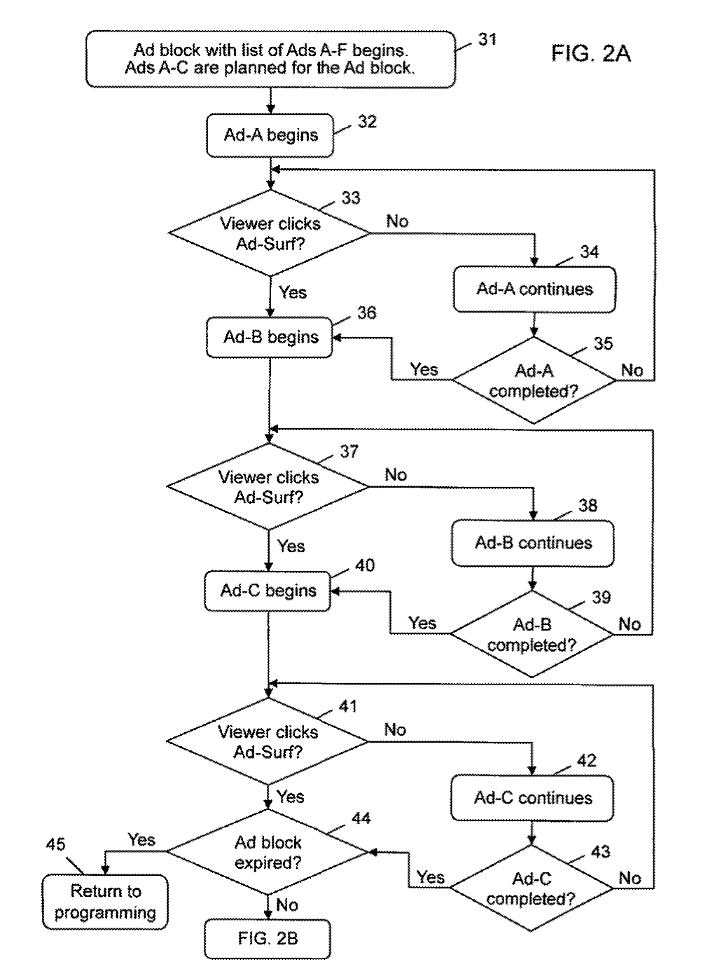

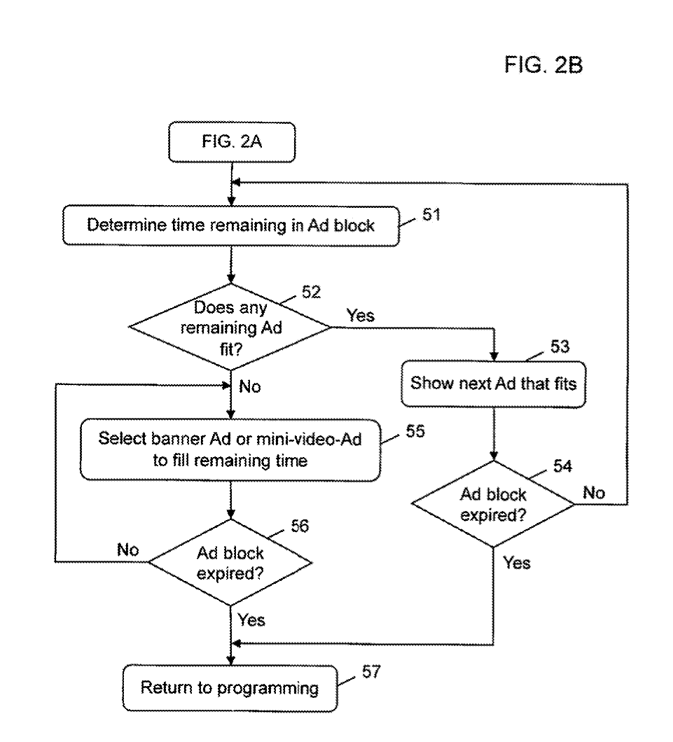

FIGS. 2A-2B are portions of a flow chart illustrating the steps of an exemplary embodiment of the method of the present invention. Referring first to FIG. 2A, at step 31 an Ad block with a list of advertisements A-F begins. If played in full, advertisements A-C are planned for the AD block. At step 32, Advertisement-A begins. At step 33, it is determined whether the viewer clicks the Ad-Surf button on the Ad Selection Mechanism 24. If not, Advertisement-A continues at step 34. At step 35 it is determined whether Advertisement-A is completed. If not, the method returns to step 33 and monitors whether the view clicks the Ad-Surf button. If the viewer clicks the Ad-Surf button at step 33, or if Advertisement-A is completed at step 35, the method moves to step 36 where Advertisement-B begins.

At step 37, it is determined whether the viewer clicks the Ad-Surf button on the Ad Selection Mechanism 24. If not, Advertisement-B continues at step 38. At step 39 it is determined whether Advertisement-B is completed. If not, the method returns to step 37 and monitors whether the view clicks the Ad-Surf button. If the viewer clicks the Ad-Surf button at step 37, or if Advertisement-B is completed at step 39, the method moves to step 40 where Advertisement-C begins.

At step 41, it is determined whether the viewer clicks the Ad-Surf button on the Ad Selection Mechanism 24. If not, Advertisement-C continues at step 42. At step 43 it is determined whether Advertisement-C is completed. If not, the method returns to step 41 and monitors whether the view clicks the Ad-Surf button. If the viewer clicks the Ad-Surf button at step 41, or if Advertisement-C is completed at step 43, the method moves to step 44 where it is determined whether the Ad block has expired. If so, the method moves to step 45 where the system returns to the regular TV programming. However, if the Ad block has not expired, the method moves to FIG. 2B.

Referring to FIG. 2B, the method continues at step 51 where the remaining time in the Ad block is determined. At step 52, the advertising unit determines whether any of the remaining Advertisements-D, E, or F will fit within the remaining time. If so, the method moves to step 53 where the next advertisement that fits is shown. At step 54, it is determined whether the Ad block has expired. If so, the method moves to step 57 where the system returns to the regular TV programming. However, if the Ad block has not expired, the method returns to step 51 and determines the remaining time in the Ad block.

The process then repeats steps 52-54 and shows the next advertisement that fits if there are any. However, if none of the remaining advertisements will fit within the remaining time in the Ad block, the method moves to step 55 where the advertising unit selects a banner advertisement or a mini-video-advertisement to fill the remaining time. At step 56, it is determined whether the Ad block has expired. If so, the method moves to step 57 where the system returns to the regular TV programming. However, if the Ad block has not expired, the method returns to step 55 where another banner advertisement or mini-video-advertisement is selected to fill the remaining time. When the AD block expires, the system returns to the regular TV programming at step 57.

Monitoring what advertisements viewers watch provides a better estimate of an advertisement's effectiveness. It may also enable different pricing models to be utilized for advertising avails. For example, advertisers may pay a flat fee plus a variable fee based on how much of their advertisement was actually viewed. The system also captures demographic data for a given program since it provides an alternative to the DVR method of advertisement skipping with time-shifted viewing habits.

Additionally, having a VOD alternative for advertisements, even in a broadcast setting, enables advantage to be taken of VOD-specific advertisement capabilities, such as targeted advertisements, and the like.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A computer-controlled method in an interactive advertisement unit for enabling a television viewer to select between a plurality of advertisements scheduled for an advertising block of time, the method comprising the steps of:
starting to show an advertisement;
monitoring by a server, a communication link to an advertisement selection mechanism controlled by the viewer;
receiving by the server, an indication that the viewer activated the advertisement selection mechanism; and
in response to receiving the indication, stopping the advertisement currently being shown and starting another advertisement.

2. The method according to claim 1, wherein a first set of advertisements are planned for the advertising block, and a larger second set of advertisements is available for viewing if the viewer activates the advertisement selection mechanism, and advertisements or portions of advertisements are skipped.

3. The method according to claim 2, further comprising the steps of:
determining that all advertisements in the first set of advertisements have been shown or skipped;
determining whether the advertising block of time has expired;
if the advertising block of time has expired, returning to television programming;
if the advertising block of time has not expired:
determining the time remaining in the advertising block of time;
determining whether any advertisements remaining in the second set of advertisements fit within the time remaining in the advertising block of time; and
when at least one advertisement remaining in the second set of advertisements fits within the time remaining in the advertising block of time, showing a next advertisement that fits within the time remaining in the advertising block of time.

4. The method according to claim 3, further comprising the steps of:
when the advertising block of time has not expired, and there are no advertisements remaining in the second set of advertisements that fit within the time remaining in the advertising block of time, showing a banner advertisement until the advertising block of time expires; and
returning to television programming when the advertising block of time expires.

5. The method according to claim 3, further comprising the steps of:
when the advertising block of time has not expired, and there are no advertisements remaining in the second set of advertisements that fit within the time remaining in the advertising block of time, showing a mini-video-advertisement until the advertising block of time expires; and
returning to television programming when the advertising block of time expires.

6. The method according to claim 3, further comprising the steps of:
storing in a database, information relating to which advertisements were entirely viewed and which advertisements were partially viewed or skipped.

7. The method according to claim 6, wherein the step of storing information relating to which advertisements were partially viewed includes storing an indication of a length of time each partially viewed advertisement was viewed.

8. The method according to claim 1, wherein the step of receiving the indication that the viewer activated the advertisement selection mechanism includes receiving the indication through a Set Top Box (STB) in communication with the server.

9. The method according to claim 1, wherein the step of receiving the indication that the viewer activated the advertisement selection mechanism includes receiving the indication through an Internet connection between the server and the advertisement selection mechanism.

10. An interactive advertisement selection system for enabling a television viewer to select between a plurality of advertisements scheduled for an advertising block of time, the system comprising:
a list of advertisements to be shown to the viewer during the advertising block of time;
an advertisement selection mechanism controlled by the viewer; and
an advertisement selection server in communication with the advertisement selection mechanism, wherein the server includes:
communication means for receiving an indication that the viewer activated the advertisement selection mechanism; and
means, responsive to receiving the indication, for stopping an advertisement currently being shown, selecting a next advertisement from the list of advertisements, and starting the selected next advertisement.

11. The system according to claim 10, wherein the list of advertisements includes a first set of advertisements planned for the advertising block, and a larger second set of advertisements that are available for viewing if the viewer activates the advertisement selection mechanism, and advertisements or portions of advertisements are skipped.

12. The system according to claim 11, further comprising a database for storing information relating to which advertisements were entirely viewed and which advertisements were partially viewed or skipped.

13. The system according to claim 12, wherein the information relating to which advertisements were partially viewed includes information regarding a length of time each partially viewed advertisement was viewed.

14. The system according to claim 10, wherein the server receives the indication that the viewer activated the advertisement selection mechanism through a Set Top Box (STB) in communication with the server.

15. The system according to claim 14, wherein the advertisement selection mechanism is a television remote control in communication with the STB.

16. The system according to claim 10, wherein the server receives the indication that the viewer activated the advertisement selection mechanism through an Internet connection between the server and the advertisement selection mechanism.

17. The system according to claim 16, wherein the advertisement selection mechanism is a computing device having an Internet connection, wherein the computing device is selected from a group consisting of:
a laptop computer;
a notebook computer;
a programmable smart phone; and
a Personal Digital Assistant (PDA).

18. An advertisement selection server in an interactive advertising unit for enabling a television viewer to select between a plurality of advertisements scheduled for an advertising block of time, the server comprising:
communication means for receiving from an advertisement selection mechanism at the viewer's premises, an indication that the viewer activated the selection mechanism; and
means, responsive to receiving the indication, for stopping an advertisement currently being shown and starting another advertisement.

19. The server according to claim 18, wherein the means for stopping the advertisement currently being shown and starting the other advertisement includes means for selecting the other advertisement from a list of advertisements to be shown to the viewer during the advertising block of time, wherein the list includes a first set of advertisements planned for the advertising block, and a larger second set of advertisements that are available for viewing if the viewer activates the advertisement selection mechanism, and advertisements or portions of advertisements are skipped.

20. The server according to claim 19, wherein when all advertisements in the first set of advertisements have been shown or skipped, the advertisement selection server is configured to determine whether the advertising block of time has expired, and to return to television programming if the advertising block of time has expired.

21. The server according to claim 19, wherein when all advertisements in the first set of advertisements have been shown or skipped, the advertisement selection server is configured to determine whether the advertising block of time has expired, and if the advertising block of time has not expired, the server determines the time remaining in the advertising block of time; determines whether any advertisements remaining in the second set of advertisements fit within the time remaining in the advertising block of time; and when at least one advertisement remaining in the second set of advertisements fits within the time remaining in the advertising block of time, the server shows a next advertisement that fits within the time remaining in the advertising block of time.

22. The server according to claim 21, wherein when the advertising block of time has not expired, and there are no advertisements remaining in the second set of advertisements that fit within the time remaining in the advertising block of time, the server is configured to show a banner advertisement until the advertising block of time expires, and to return to television programming when the advertising block of time expires.

23. The server according to claim 21, wherein when the advertising block of time has not expired, and there are no advertisements remaining in the second set of advertisements that fit within the time remaining in the advertising block of time, the server is configured to show a mini-video-advertisement until the advertising block of time expires, and to return to television programming when the advertising block of time expires.

24. The server according to claim 18, further comprising means for storing in a database, information relating to which advertisements were entirely viewed and which advertisements were partially viewed or skipped.
